(19) United States
(12) Patent Application Publication
(10) Pub. No.: US 2003/0189584 A1
(43) Pub. Date: Oct. 9, 2003

(54) Schedule display control device, method, and recording medium

(76) Inventor: Yoshiki Watanabe, Tokyo (JP)

Correspondence Address: STAAS & HALSEY LLP, SUITE 700, 1201 NEW YORK AVENUE, N.W., WASHINGTON, DC, 20005, US

(21) Appl. No.: 09/521,448

(22) Filed: Mar. 7, 2000

(30) Foreign Application Priority Data
Mar. 12, 1999 (JP) 11-067429

(51) Int. Cl. G09G 5/00

(52) U.S. Cl. 345/700

(57) ABSTRACT

A schedule display control device, a display control method, and a computer readable recording medium storing a program which allows easy comprehension of a display unit or overall schedule, smooth operation, and sharing of schedule display control, alleviating the burden on the user. A layout control device which controls the layout of a schedule table based on the schedule quantity in individual display units and which controls the display of a schedule according to positions within said schedule table.

### CROSS REFERENCE TO RELATED APPLICATIONS

This Application is based on, and claims priority to, Japanese application 11-067429, filed Sep. 3, 1998, in Japan, and which is incorporated herein by reference.

### BACKGROUND OF THE INVENTION

1. Field of the Invention

The present invention concerns a schedule display control device used by an activity management device such as a multi-user system which manages the group activities of a plurality of people, or by a personal data management device such as a personal data assistant (PDA) or personal information manager (PIM). More specifically, the invention relates to one of the previous devices which are equipped with functions for multiple categories such as a schedule, a to-do list, an address record (contacts), and e-mail. The present invention particularly concerns a technology which displays a schedule in a manner whereby a user can easily view the schedule. The present invention also includes a process and a corresponding computer readable storage medium containing the process.

2. Description of the Related Art

FIG. 1 is a drawing depicting related art and illustrates display of a schedule on a screen of a display device using a schedule function. FIG. 1 illustrates an example wherein a schedule for March, 1999 is displayed in a monthly display mode.

As illustrated in FIG. 1, in the schedule display according to the monthly display mode, an upper area of the display displays the year and month of the schedule to be displayed, and each day of the week. The lower area of the display displays a matrix-shaped frame, the progression of dates corresponding to each day, and frames for the series of days.

A starting time and an item name in a schedule are displayed in a frame corresponding to the date for which a schedule is set. Thus, in the monthly display mode, each day comprises a display unit.

For example, “9:00 Meeting 1,” “14:00 Meeting 2,” and “17:00 Meeting 3” is set for March 2nd, and the starting time and item name for each meeting is displayed within the frame corresponding to the location for March 2nd. Respective starting times and item names are similarly displayed within other frames corresponding to dates for which a schedule is set.

Day-long schedules, holidays, or other such schedules where time periods are irrelevant are in particular termed “events,” and the item name of such an event is displayed by reverse-display, as in the case of March 5, “Vacation.”

For days for which the set schedule cannot be fully displayed within the frame (such as March 24, where “17:00 Technology Presentation” not displayed is set as part of the schedule), a scroll bar allowing vertical scrolling of display contents is displayed within the frame for that day, and by operating this scroll bar, a user exercises control allowing display of schedule information not displayed within the frame.

When a single schedule cannot be displayed in a single row, control is exercised such that the final portion is replaced by a “.” and the display content is abbreviated and displayed within the frame so that each schedule is displayed in a single row.

In other related art, control is exercised such that, when a frame is clicked with a mouse cursor or the like and the focus is applied to that frame, the display area of the frame is temporarily enlarged, and the full schedule for the day corresponding to that frame is displayed.

Display formats other than starting time and item name can also be selected for schedules already set; for example, starting time and ending time or item name, or item name alone.

Schedule display modes are also not limited to the monthly display mode in the present example; there is also a weekly display mode which displays the schedule for each day in a one-week period, and a daily display mode which displays the schedule for each time period in a single day. The display unit in weekly display mode and daily display mode is the hour.

The above-described related art entails numerous problems. First, the schedule is hard to view. As discussed above, because the entire contents of an individual schedule is not displayed within the display area of a frame, and the entire schedule for a single day is not displayed, it is ultimately difficult to view individual schedules and to view the schedule for an entire day. Because the schedule for a given day cannot be viewed, a monthly schedule can no longer be viewed either. In essence, it is simply difficult to view an overall schedule.

Another problem with the prior art is that the user is burdened. As discussed above, when an entire schedule cannot be displayed within the display area of a frame, a scroll bar must be operated or some other operation placing the focus on a frame must be carried out, which places an operating burden on the user.

A further problem with the prior art is that wasted display area results. As in FIG. 1, the size of frames corresponding to individual days is identical, which serves no purpose when there are weeks or days where no schedule at all is registered and no schedule at all is displayed in the display area for those weeks or days, resulting in a waste of display area on the screen. If a schedule table is for this reason displayed as one window in a multi-window system, the schedule table is superimposed on a window used by other application software, or the size of the window must be reduced so that it is not superimposed, which impedes the work of the other application software.

An additional problem with the prior art is that a schedule display control cannot be shared with other computing platforms. In an aforementioned PIM or other such personal information management device, only schedule-related content is output as data, and the output data can be read by another personal information management device to display a schedule. However, the other personal information management device can reproduce only the schedule content, and it is not possible to reproduce the actual schedule display of the personal information management device that output the schedule as data.

### SUMMARY OF THE INVENTION

Accordingly, an object of the present invention is to offer a schedule display control device, a display control method, and a computer-readable recording medium storing a program which allows easy apprehension of a display unit or overall schedule, alleviation of the operating burden on a user, smooth operation, and sharing of schedule display control.

Additional objects and advantages of the invention will be set forth in part in the description which follows, and in part, will be obvious from the description, or may be learned by practice of the invention.

Objects of the present invention are achieved by controlling a layout of a schedule table based on the schedule quantity of each display unit, and the present invention controls the display of a schedule according to the schedule table of the layout and relevant positions within said schedule table. The schedule table can comprise rows and columns, and the schedule table layout is controlled so as to assume a width of each row and/or column that corresponds to the schedule quantity.

The schedule quantity is the display content quantity of the schedule in each row or each column with the largest number of items and/or the schedule requiring the largest display area, and the aforementioned schedule table layout is controlled so as to display each schedule with the largest number of items and/or the aforementioned schedule requiring the largest display area. The schedule table and the data controlling schedule display can be output to a file of a format readable by another computing platform.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is a drawing illustrating a schedule display according to the prior art.

FIG. 2 is a drawing illustrating the hardware structure of a personal information management device.

FIG. 3 is a drawing illustrating a schedule display according to an embodiment of the present invention.

FIG. 4 is a drawing illustrating a schedule display according to another embodiment of the present invention.

FIG. 5 is a drawing illustrating a schedule display according to an additional embodiment of the present invention.

FIG. 6 is a drawing illustrating a data structure of schedule data according to the present invention.

FIG. 7 is a drawing illustrating a flowchart which describes schedule display control according to the present invention.

FIG. 8 is a drawing illustrating an instruction screen for output of schedule data as an HTML document according to the present invention.

FIG. 9 is a drawing illustrating a flowchart which describes output of schedule data as an HTML document according to the present invention.

### DESCRIPTION OF THE PREFERRED EMBODIMENTS

Reference will now be made in detail to the present preferred embodiments of the present invention, examples of which are illustrated in the accompanying drawings.

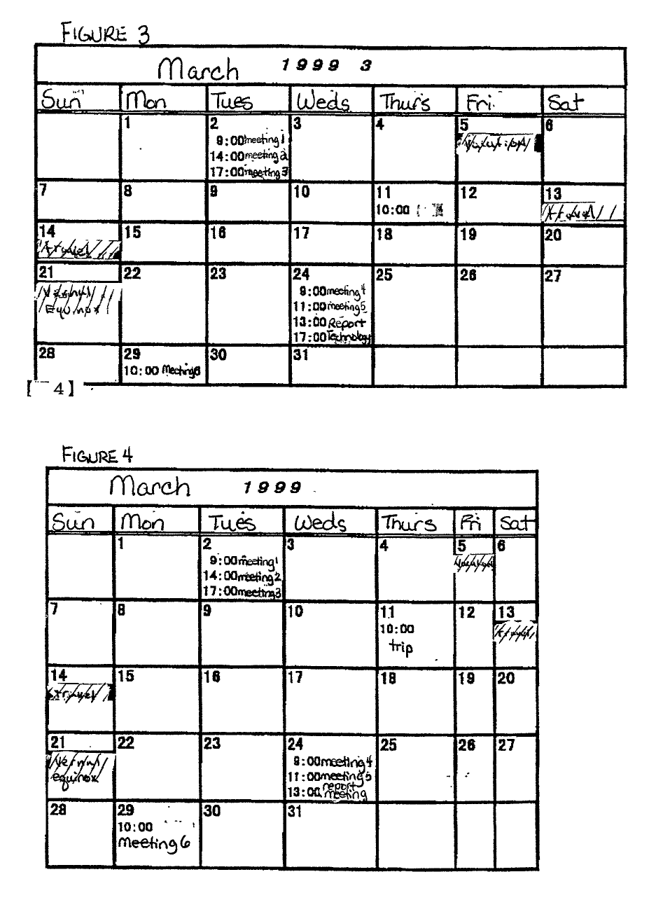

FIG. 2 is a drawing illustrating the hardware structure of a personal information management device. The hardware of the personal information management device 1 representing the present preferred embodiment has a structure akin to that of a personal computer or other such well-known, ordinary hardware. Specifically, said structure comprises a CPU 10 which executes various processing and control; a ROM 11 wherein a BIOS or other such control program is used to execute setup of various environments for devices at startup; a main memory device comprising RAM wherein a program or data used to execute processing has been presented; an auxiliary memory device such as a hard disk drive 13, floppy disk drive 14, or CD-ROM drive 15 which stores an operating system or various application programs and data; a telecommunications control device such as a network control board 16 or a modem 17 used to access a remoter server or mail server; an input device such as a keyboard 18 or mouse 19 which functions for text input or as a pointing device; and a display device 20 which carries out display on a screen; and an internal bus in a manner allowing transmission and reception of data. From a memory device managed by a remote server and by way of an auxiliary memory device or telecommunications control device, a schedule display control program pertaining to the present invention is presented to the main memory device, and through the execution of said program, the CPU 10 exercises control such that the hardware is operated as a personal information management device 1.

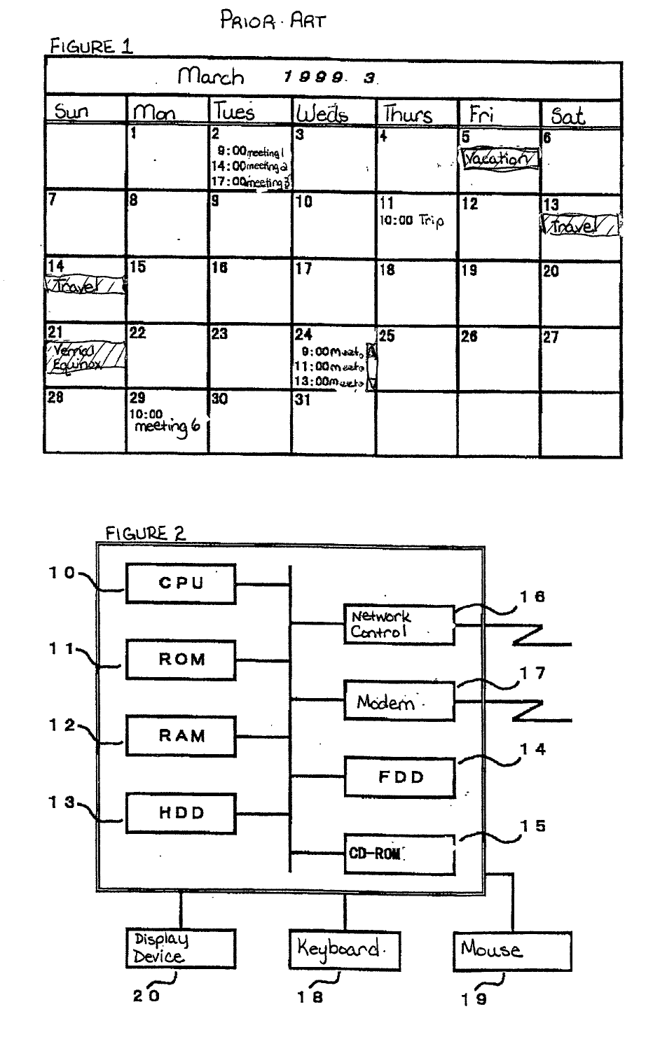

FIG. 3 is a drawing illustrating operation of the present invention and depicts a schedule table displaying the same schedule content as in FIG. 1.

The schedule table shown in FIG. 3 differs from the schedule table pertaining to the prior art in FIG. 1 in that the row width of the table corresponding to each week is adjusted according to the largest number of schedule items in each week

Specifically, the row width for row 1 corresponding to the first week is adjusted so as to display the entire schedule for March 2, where three items are registered.

The row width of row 2 corresponding to the second week and of row 3 corresponding to the third week is in each case adjusted so as to display the one-item schedule registered for each of March 11, March 13, and March 14.

The row width of row 4 corresponding to the fourth week is adjusted so as to display the entire schedule for March 24, where four items are registered. Here, “17:00 Technology Presentation” registered in the schedule on March 24 was not displayed by the related art in FIG. 1, but in FIG. 3, this schedule item is displayed in abbreviated form according to the display abbreviation processing described in the related art.

Consequently, a user need not operate a scroll bar or perform a focus setting operation as in the related art, and the entire schedule for a single day can now be viewed.

The row width of row 5 corresponding to the fifth week is adjusted so as to display the one-item schedule for March 29, as in rows 2 and 3.

In this way, the row width of each row corresponding to each week can be changed according to the largest number of schedule items registered in each instance. Thus, row width is narrowed for rows corresponding to weeks where there are few schedule items registered or no schedule at all registered, as in the past, and a display area can be used effectively.

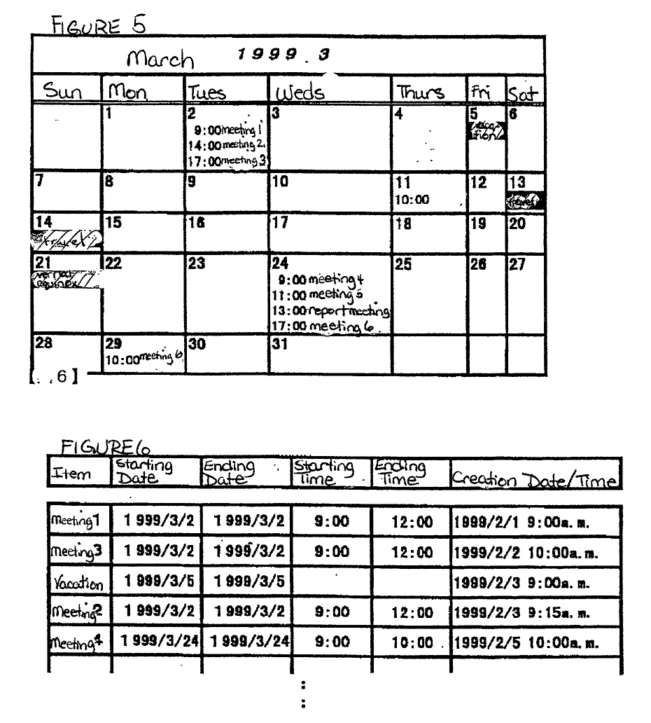

FIG. 4 is a figure illustrating an additional embodiment of the present invention and depicts a schedule table displaying the same schedule content as in FIG. 1.

The schedule table shown in FIG. 4 differs from the schedule table pertaining to the related art in FIG. 1 in that when schedule content is displayed, the column width of the table is adjusted for each day of the week according to the date requiring the largest display area.

Specifically, the column width of column 1 corresponding to Sunday is adjusted so as to fully display “Vernal Equinox,” the schedule content for March 21.

The column width of each column corresponding to other days of the week is similarly controlled so as to fully display the schedule content for each column, namely, “10:00 Meeting 6” on March 29 in column 2 corresponding to Monday, either “14:00 Meeting 2” or “17:00 Meeting 3” on March 2 in column 3 corresponding to Tuesday, “13:00 Report Meeting” on 5 March 24 in column 4 corresponding to Wednesday, “10:00 Trip” on March 11 in column 5 corresponding to Thursday, “Vacation” on March 5 in column 6 corresponding to Friday, and “Travel” on March 13 in column 7 corresponding to Saturday.

In this way, the schedule content registered in each column corresponding to each day of the week is displayed fully, and the column widths can be changed so as to achieve minimization. Thus, a schedule is no longer displayed in abbreviated form, with characters not displayed replaced by “.”, as in the prior art, and the content of each schedule is rendered easy to view. In addition, the largest display content of a schedule is small (the number of displayed characters is small), column width is small in columns corresponding to days of the week where no schedule at all is registered, and a display area is used effectively.

FIG. 5 is a figure illustrating an additional embodiment of the present invention and depicts a schedule table displaying the same schedule content as in FIG. 1.

The schedule table depicted in FIG. 5 differs from the schedule table pertaining to the related art in FIG. 1 in that the row width of the table corresponding to each week is adjusted according to the largest number of schedule items in each week, and in that when schedule content is displayed, the column width of the table is adjusted for each day of the week according to the date requiring the largest display area.

Specifically, the display control of the schedule table that is carried out combines the schedule table row width control and the schedule table column width control according to the pervious embodiments of the present invention.

Because the schedule table row width and column width control is a combination of the control content described in the previously described embodiments, a detailed description concerning this embodiment is omitted.

The structure of the schedule data used in the above-noted schedule table is described below.

FIG. 6 is a drawing illustrating the data structure of schedule data.

As depicted in FIG. 6, schedule data for each schedule comprises fields of item name, starting date, ending date, starting time, ending time, and creation date/time. Schedule data fields are also not limited to these fields alone and include fields such as alarm setting ON/OFF and alarm time. Here, creation date/time indicates the date and time when schedule data was created, and schedule data is stored in an auxiliary memory device in creation date/time order.

For example, when an instruction is given for March, 1999 schedule display, storage addresses for each schedule data item possessing a starting date within the period from Mar. 1, 1999 to Mar. 31, 1999 are collected, and these storage addresses are sorted in order of starting date, starting time, ending date, and ending time to create index data.

Using said index data, schedule data with the relevant dates is then read from the auxiliary memory device and presented to a main memory device, and schedule content is displayed together with a schedule table. Here processing is simply described in terms of index data, but actual processing follows the subsequent description.

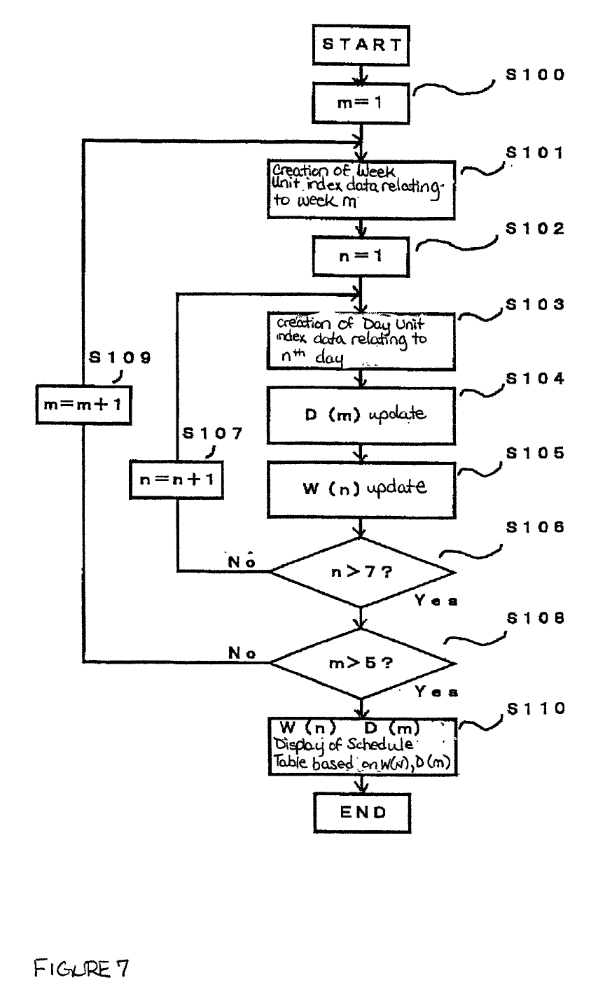

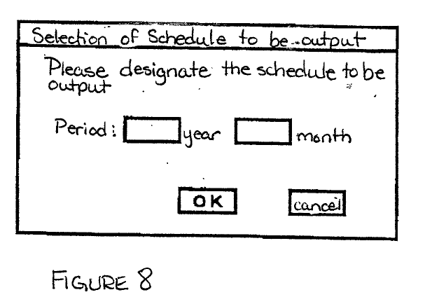

The flowchart in FIG. 7 is used to describe processing which carries out schedule display control using the schedule data.

FIG. 7 is a drawing depicting a flowchart which describes schedule display control pertaining to the present invention.

FIG. 7 depicts the processing flowchart in monthly display mode.

When an instruction is given for schedule table display, array W(m) which controls weekly display width and comprises 5 elements and array D(n) which controls day of week display width and comprises 7 elements are first stored in a main memory device, and each value is initialized.

Then, in step S100, a variable m indicating the ordinal week is set to 1.

Next, week unit index data relating to the m^{th} week is created in step S101. This week unit index data is created by collecting the storage addresses of schedule data for each date in the m^{th} week and sorting these addresses as described above.

After week unit index data for week m is created, a variable n indicating the ordinal day of the week (i.e., a variable indicating the day of the week) is set to 1 in step S102, and day unit index data relating to the n^{th} day is created in step S103. This day unit index data is created by collecting the storage addresses of schedule data for the n^{th} day and sorting these addresses in starting time order.

During processing to create the aforementioned day unit index data, the number of schedule items in the n^{th} day and the largest number of characters in the schedule display content are stored, an existing stored value (number of characters) in array D(n) is compared with the largest number of characters for the n^{th} day in step S104, and the larger number of characters is set as the new stored value in array D(n). In step S105, an existing stored value (number of items) in array W(m) and the number of schedule items in the n^{th} day are compared, and the larger number of items is set as the new stored value in array W(m).

Up to day 7, step 106 determines whether processing in steps S103 and S104 has been executed; if variable n is less than 7, variable n is increased by 1 in step S107, and steps S103 and S104 are executed.

If variable n is greater than 7, step S108 determines whether processing has been executed up to week m; if variable m is less than 5, variable m is increased by 1 in step S109, and the aforementioned processing is executed again.

If variable m is greater than 5, the largest number of items in the schedule for each week and the largest character count of schedule display contents for each day of the week have been determined. Thus, in step S110, the display width for each week and the display width for each day of the week are then determined based on the value of each element of array W(m) and D(n) and on a character font size set for the purpose of displaying schedule content, and schedule table frames and the contents of each schedule stored at addresses indicated by index data are displayed on screen.

The processing described above controls the display width for each week and the display width for each day of the week corresponding in each case to the third preferred embodiment and displays a schedule table on a screen; however, the first preferred embodiment can be effected by fixing the value of each element in array D(n), which controls the display width of each day of the week, and the second preferred embodiment can be effected by fixing the value of each element in array W(m), which controls the display width of each week.

Though the foregoing processing controls the display width of each week and each day of the week in monthly display mode, it is naturally the case that, by changing the number of elements of each row and column to suit each display mode and carrying out processing similar to that above, schedule display control can also be effected in weekly display mode for each day of the week, corresponding to a column, and for each time, corresponding to a row, and in daily display mode for each time, corresponding to a row, and for each day, corresponding to a column (number of columns: 1).

The foregoing is an example of schedule display control through processing by a personal information management device comprising a preferred embodiment of the present invention.

Next is described an example wherein schedule data processed by such a personal information management device is output as an HTML document. Opening an HTML document output by this processing with a WWW browser or similar function allows on-screen display of a schedule table provided with the above-discussed display control even by another processing device not endowed with personal informational management functions (HTML refers to hypertext markup language).

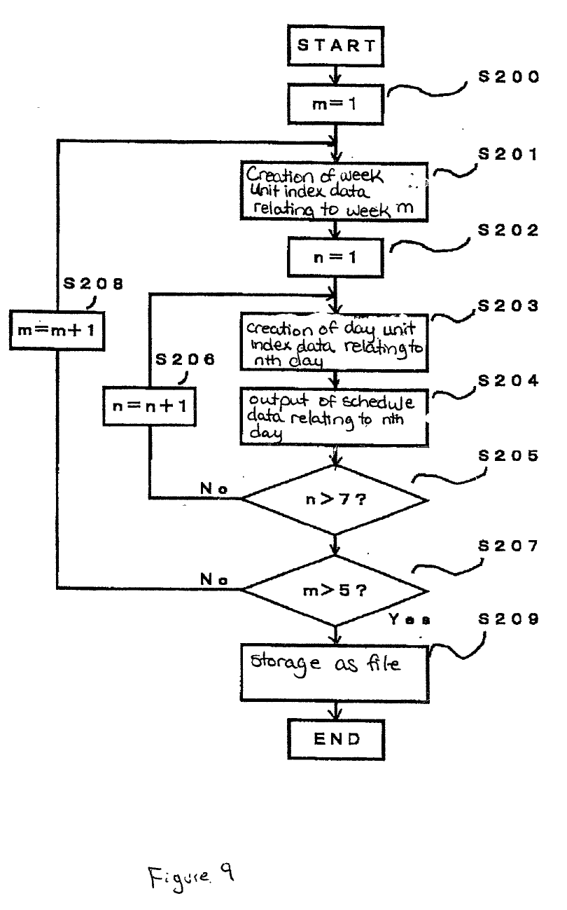

When an instruction is given to output schedule data as an HTML document, a window for designating the period of schedule data to be output, like that depicted in FIG. 8, is displayed on screen. In this example, only a month and year can be designated as a period, but various methods for designation may be conceived, such as designation of the week number to be output.

When a user designates in this window the period to be output, processing is executed based on the flowchart depicted in FIG. 9.

FIG. 9 is a drawing depicting a flowchart for output of schedule data as an HTML document.

When a user designates in the window in FIG. 8 the desired month and year and presses the OK button, a <TABLE> tag defining the attribute that sets the HTML width and a <TR> tag indicating the row are first recorded in a file. The day of the week is then inserted between a <TD> tag indicating the column and a </TD> tag, and this is added to the file. A day of the week header is thereby recorded in the file.

In step S200, the variable m indicating the ordinal week is then set to 1.

In step S201, week unit index data relating to week m is then created, and a <TR> tag indicating the row is added to the file. The method for creating this week unit index data is the same as in step S101 in the above-discussed FIG. 7, and a description is therefore omitted.

In step S202, variables n indicating the (ordinal) day of the week are then each set to 1.

Day unit index data for the n^{th} day is then created in step S203. The method for creating this day unit index data is the same as in step S103 in the above-discussed FIG. 7, and a description is therefore omitted.

When day unit index data is created, in step S204 schedule data is read in order from the addresses designated by said index data, and schedule content enclosed by <TD> and </TD> is added to the aforementioned file. At such time, if a plurality of schedule data is present, a paragraph tag (<P>) is inserted among the schedule data and recorded. If there is no schedule data, <TD> and </TD> are simply added to the file.

Up to the seventh day, step S205 determines whether step S203 and S204 processing has been executed; if variable n is less than 7, variable n is increased by 1 in step S206, and steps S203 and S204 are carried out.

If variable n is greater than 7, step 207 determines whether processing has been executed up to week m, and if variable m is less than 5, variable m is increased by 1 in step S208, and the aforementioned processing is executed again.

If variable m is greater than 5, schedule data for each week has been recorded in the file; thus, in step S209, </TABLE > is added, and the file is stored with a predetermined file name in an auxiliary memory device.

Opening a file created as described above with a WWW browser allows on-screen display of a schedule table wherein the display width has been set according to the number of schedule items in each week.

Though mention is omitted in the foregoing description, it is of course the case that the screen display depicted in the preferred embodiments can be effected by entering in an HTML page the desired period (month, year, etc.) of the schedule to be viewed.

Accordingly, opening said HTML document file with a processing device not endowed with personal information management functions brings about a reflection of schedule display control in the other processing device.

As described above, the present invention affords one of, a combination of any number of, or all of: easy apprehension of a display unit or overall schedule, alleviation of the operating burden on a user, smooth operation, and sharing of schedule display control.

Although a preferred embodiment of the present invention has been shown and described, it would be appreciated by those skilled in the art that changes may be made in this embodiment without departing from the principles and spirit of this invention, the scope of which is defined in the claims and their equivalents.

What is claimed is:

1. A schedule display control device comprising:
a layout control device forming a layout of a schedule table based on a schedule quantity of a plurality of display units; and
a display control device controlling display of the schedule table according to the layout.

2. The schedule display control device according to claim 1, wherein:
the schedule table comprises rows and columns, and
the layout control device forms the layout to adjust a size of rows and/or columns corresponding to the schedule quantity.

3. The schedule display control device according to claim 1, wherein:
the schedule quantity is a space required for a schedule in a row or a column with a largest number of items and/or the schedule requiring a largest display area, and
the layout control device forms the layout such that each display unit with the largest number of items and/or the schedule requiring the largest display area is displayed.

4. The schedule display control device according to claim 1, wherein the display control device outputs data controlling the schedule table and the schedule display to a file of a format interpretable by another processing platform.

5. A schedule display control method which controls the display of a schedule table, wherein said schedule display control method comprises:
controlling a layout of a schedule table based on a schedule quantity of a plurality of display units; and
displaying the schedule table using the layout.

6. The schedule display control method according to claim 5, further comprising:
forming rows and columns in the schedule table; and
adjusting a width of each row and/or each column corresponding to the schedule quantity.

7. The schedule display control method according to claim 5, further comprising:
computing the schedule quantity from a display content quantity of the schedule in each row or each column with the largest number of items and/or the schedule requiring a largest display area; and
displaying the schedule requiring the largest display area.

8. The schedule display control method according to claim 5, further comprising outputting the schedule table and the schedule display to a file of a format interpretable by another processing platform.

9. A computer-readable storage medium storing software performing the process of:
controlling a layout of a schedule table based on a schedule quantity a plurality of display units; and
displaying the schedule table using the layout.

10. The computer readable storage of claim 9 further comprising:
forming rows and columns in the schedule table; and
adjusting a width of each row and/or each column corresponding to the schedule quantity.

11. The computer readable storage medium of claim 9 further comprising:
computing the schedule quantity from a display content quantity of the schedule in each row or each column with the largest number of items and/or the schedule requiring a largest display area; and
displaying the schedule requiring the largest display area.

12. The computer readable storage medium of claim 9 further comprising outputting the schedule table and the schedule display to a file of a format interpretable by another platform.

13. A schedule display control device comprising:
a layout device dividing a calendar period into a plurality of display units containing information, said display units formed in rows, and adjusting a length of the display units of each row to match the display unit in a respective row containing a largest size of information; and
a display device displaying the display units with their corresponding information inside.

14. A schedule display control device comprising:
a layout device dividing a calendar period into a plurality of display units containing information, said display units formed in columns, and adjusting a width of the display units of each column to match the display unit in a respective column containing a largest size of information; and
a display device displaying the display units with their corresponding information inside.

15. A schedule display control device comprising:
a layout device dividing a calendar period into a plurality of display units containing information, said display units formed in rows and columns;
said layout device adjusts a length of the display units of each row to match the display unit in a respective row containing a largest size of information;
said layout device adjusts a width of the display units of each column to match the display unit in a respective column containing a largest size of information; and
a display device displaying the display units with their corresponding information inside.

16. A schedule display method comprising:
dividing a calendar period into a plurality of display units containing information, said display units formed in rows;
adjusting a length of the display units of each row to match the display unit in a respective row containing a largest size of information; and
displaying the display units with their corresponding information inside.

17. A schedule display method comprising:
dividing a calendar period into a plurality of display units containing information, said display units formed in columns;
adjusting a width of the display units of each column to match the display unit in a respective column containing a largest size of information; and
displaying the display units with their corresponding information inside.

18. A schedule display method comprising:
dividing a calendar period into a plurality of display units containing information, said display units formed in rows and columns;
adjusting a length of the display units of each row to match the display unit in a respective row containing a largest size of information;
adjusting a width of the display units of each column to match the display unit in a respective column containing a largest size of information; and
displaying the display units with their corresponding information inside.

19. A computer readable storage media storing a schedule display process comprising:
dividing a calendar period into a plurality of display units containing information, said display units formed in rows;
adjusting a length of the display units of each row to match the display unit in a respective row containing a largest size of information; and
displaying the display units with their corresponding information inside.

20. A computer readable storage media storing a schedule display process comprising:
dividing a calendar period into a plurality of display units containing information, said display units formed in columns;
adjusting a width of the display units of each column to match the display unit in a respective column containing a largest size of information; and
displaying the display units with their corresponding information inside.

21. A computer readable storage media storing a schedule display process comprising:
dividing a calendar period into a plurality of display units containing information, said display units formed in rows and columns;
adjusting a length of the display units of each row to match the display unit in a respective row containing a largest size of information;
adjusting a width of the display units of each column to match the display unit in a respective column containing a largest size of information; and
displaying the display units with their corresponding information inside.
